(19) United States
(12) Patent Application Publication
(10) Pub. No.: US 2008/0133476 A1
(43) Pub. Date: Jun. 5, 2008

(54) AUTOMATED PEER PERFORMANCE MEASUREMENT SYSTEM FOR ACADEMIC CITATION DATABASES

(76) Inventor: Ivo Welch, Providence, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/566,698

(22) Filed: Dec. 5, 2006

(51) Int. Cl. G06F 17/30

(52) U.S. Cl. 707/3; 707/E17.108

(57) ABSTRACT

An automated query interface for searching academic citation databases is provided. The system of the present invention allows a user to query not just either the relative performance metrics and rankings of academic publications or the similarity of academic publications, but to query for the relative ranking of aggregations such as researchers, institutions and journals and relative to a set of similar “peers” that (usually) have also been obtained by the system itself via an automated similarity rating engine. The system intentionally deemphasizes or suppresses results for dissimilar researchers, institutions or journals, and seeks to present similar researchers, institutions, and journals together and relative to one another.

### BACKGROUND OF THE INVENTION

The present invention relates generally to the field of information science and searchable databases. More specifically, the present invention is related to an enhanced search engine that allows contextual searching of academic citation databases. In such academic citation databases, individual academic works represent single entries. The articles can be grouped into works by particular researchers, thus forming a larger class. Similar larger classes are institutions and journals.

Such automated academic citation databases have existed for decades. These systems are simply specialized databases that primarily contain linked citations of publications or articles in an organizational structure that allows end users to query the database, e.g., based on article or author. For example, three prominent such databases include ISI Thomson, Elsevier Scopus and Google Scholar, all trademarked.

The structure of these academic citation databases is generally analogous in nature to the structure of the World Wide Web. In the web context, a single web page is the equivalent of an article whereby the single item has links from and to it. Thus, many inventions pertaining to the World Wide Web are also applicable to academic citation or bibliographic databases. In fact, the World Wide Web is often used as an illustration for bibliographic databases and vice-versa. Google!Scholar even bridges the two different environments by, providing a scientific article database based on papers that are posted on the web. These prior art databases are commonly used for at least three conventionally defined purposes. First, they are used to produce a performance metric or ranking of individual articles (web pages). The most famous example is Google's pagerank (U.S. Pat. No. 7,058,628 B1), which is simply the eigenvector applied to the link matrix of such databases. Many variations thereof exist. For example, Broder (U.S. Pat. No. 6,560,600 B1) discloses an eigenvector ranking of an arbitrary characteristic of articles (web pages). Similarly, the most prominent bibliographic citation ranking system, ISI Impact Factor, computes the average number of cites over the most recent two years. Secondly, they are used to produce a similarity or dissimilarity ranking of articles. For example, the well-known Google search service allows searching for similar content to articles (web pages) already returned, and sometimes offers as results groups of articles (web pages) that are similar. Thirdly, they are used to produce aggregate performance measures of researchers, journals, or institutions. (The concept of aggregated categories remains the same; thus, readers skilled in the art will recognize that everything in this application applies equally well to journals and institutional affiliation, or finer categories such as researchers within a similar cohort.) The most prominent such performance measure is a simple cite count of all articles by a given researchers, e.g., as in the ISI web system. Fourth, some systems present performance metrics and/or rankings of all or at least the top researchers in a large category, like economics. These rankings are usually drawn from researchers having published in economics-related journals.

One difficulty in the prior art is that existing database search systems do not make it easy to identify appropriate peers. For example, while they can perform mechanical searches based on exact matches to researcher names or broad general categories of research such as economics, they are poor in telling the user how to interpret the performance measures—whether it is high or low. For example, articles in “growth economics” may typically have three times the performance measures than articles in “economic theory.” A great “economic theory” article may have only half as many cites as even a mediocre “growth economics” article. Many performance measures are reasonably comparable only among articles that are intrinsically similar.

This is particularly problematic when a user is interested in the performance of larger classes (aggregations of articles), e.g., researchers. Economic theorists may only appear far down the list of all ranked economists. In addition, such simple all-economics rankings would contain many non-theory researchers, and it would be difficult to determine who the appropriate good peers are. This is even more the case when a researcher has written some economic theory and some growth theory.

The existing systems only provide a listing of similar articles. To rank a an aggregation of articles, that is, a researcher, the end user has to assemble a peer group. This can be done through a painfully tedious process. For example, here is one such possible procedure a user would have to go through.
1. Search an existing citation data base's articles published by “Ivo Welch,”
2. Determine for each article the set of other similar articles,
3. Determine which researchers appear most often among the set of similar articles and/or who have similar biographic information,
4. Choose the peer group therefrom, and
5. Finally produce an output page that summarizes both the collected similarity information and provides quick access to performance measures and ranking information, perhaps adjusting (each) article performance measures for field.
   Realistically, for all but the simplest queries (e.g., researchers with few publications and potential peers), this is not a feasible task for ordinary end-users of bibliographic citation systems today. Thus, peers are often chosen based on subjective considerations. This in turn creates other problems. A user with a particular bias can make a researcher look good or bad depending on who is choosen as peers.

There is therefore a need for an academic (citation) database query system that is oriented towards and understands aggregations (broader categories, such a researcher, institution, or journal that aggregate information from many individual articles). The system should automate the process of narrowing the aggregations (members of the broader class being considered) to those that are relevant. This narrowing should be done by the system for the user, rather than be required to be specified ex-ante by the user. There is a further need for an academic database query system that makes it easy to identify results using a system that suppresses results based on dissimilarities while offering results that have the highest level of related similarity. And there is a need towards a system that makes it easy for a user to specify multiple members of a larger class to compare them side-by-side.

### BRIEF SUMMARY OF THE INVENTION

In this regard, the present invention provides an enhanced search engine that allows a particular form of contextually relevant searching of academic citation databases. The end product of the system of the present invention is an automated query system that allows an end user to measure performance relative to a set of similar entries (henceforth “peers”). It could identify not only individual papers but also aggregations (such as researchers) that are similar (“peers”), and that optionally presents relative performance metrics or rankings among the set of discovered peers. It should be further appreciated by one skilled in the relevant art that although the invention can be applied to individual articles (to present the performance among a set of articles deemed to be similar), the principal use of the invention is in the context of aggregations (the broader categories), especially researchers, researchers-of-a-cohort, institutions, or journals. The end user names a researcher, and the system delivers a set of similar researchers. The end user can then either easily access comparative performance measures for the set of researchers, or even receive these together with the similarity rating itself.

The system of the present invention represents a significant advance over existing methods since the prior art disclosures do not provide a computerized system to determine which researchers are good and appropriate peer researchers. The existing systems only provide similar articles (“atomistic”) that are grouped together and even those are presented without relative performance rankings. Thus, as stated above the end user is left to manually assemble a peer group either based on personal opinions, or through extensive additional research and effort. The present invention instead serves to automate this process.

The system of the present invention will prove to be particularly useful in personnel evaluations of researchers, where [a] a researcher has to be evaluated relative to close peers, often of similar cohort and employed in other institutions; or [b] a set of external letter writers has to be determined, who should be in this researcher's area. Both of these choices are typically very subjective. The current invention seeks to aid this process by providing an objective, automated system.

The system of the present invention is implemented as follows:

1. An end user types a search query into an interface, typically a form on the World Wide Web. The search can be free-form text, categorized text, or a choice from a list.

2. The query is transmitted to the system.

3. The system searches for the data record for this researcher. A researcher is mostly a data set of article content and biographic information.

4. The system determines the set of similar researchers (“peers”). The similarity metric itself can be computed for each researcher prior to end user use (e.g., stored in a data base or cache), or computed on the fly.

5. The system optionally searches for data records from the peers. Methods to accomplish this are familiar.

6. The system returns the results for the inquired researcher, together with the set of peers. The end user's browser displays the results. The results can either be only the set of peers (as long as the system has an easy method to then obtain performance measures researcher by researcher), or the set of peers together with further information (such as similarity ratings and performance measures).

Generally the methods necessary to accomplish each of the individual steps listed above are separately known. However, the novelty of the present lies in the combination of the above steps in a particular manner to produce a particular result. In other words, there has never been a prior art system that employs the particular steps listed above in an integrated system. Particular points of novelty in the system of the present invention lie in the fact that the present system provides common aggregation, preference towards similarity, and automated similarity ratings for aggregations, the details of which will all be discussed more completely below.

In an alternate embodiment of the system of the present invention, to make peer comparison easier, the end user is allowed to select a set of researchers for direct comparison. This fits well within the context of the embodiment described above, because the system returns the set of peers, that the end user can then compare. However, this can be a stand-alone aspect of a system, too. An end-user could select multiple researchers, possibly but not necessarily from the automated similarity rating, and receive a tabular comparison display of possibly multiple performance measures for multiple researchers.

Accordingly, it is an object of the present invention to provide an academic citation database query system that automates the process of locating relevant related information based on an initial input or query. It is a further object of the present invention to provide an academic database query system that identifies results using a similarity rating system that suppresses results based on dissimilarities (or relegates them to a less prominent visual position) while aggregating results that have the highest level of related similarity. Finally, it is an object of the present invention to provide an academic citation database that allows the results to be queried based on a number of different research features thereby only returning results relevant to the queried feature.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying descriptive matter in which there is illustrated a preferred embodiment of the invention.

### DETAILED DESCRIPTION OF THE INVENTION

Turning not to the specifics of the system of the present invention, as was stated above, the system of the present invention is implemented as follows:

1. An end user types a search query into an interface, typically a form on the World Wide Web. The search can be free-form text, categorized text, or a choice from a list.

2. The query is transmitted to the system.

3. The system searches for the appropriate data record. This record can be an aggregation (e.g., the researcher; from the data base perspective, a researcher is mostly a set of published articles and biographic information).

4. The system then looks up all similar aggregations (“peers”), in this example a researcher. The similarity metric itself can be computed for each researcher prior to end user use (e.g., stored in a data base or cache), or computed on the fly.

5. The system searches for data records from the peers. Methods to accomplish this are familiar.

6. The system returns the results for the inquired researcher, together with the results for the peers. The end user's browser displays the results, minimally just the similarity ratings, but perhaps more conveniently the relative similarity and ranks of all researchers.

In order to implement the system, the system generally requires one or more databases, computer programs (“engines”) configured to operate on the information within the databases, such as a performance measuring and ranking engines, aggregation engines, and similarity rating engines, and an interface that allows a user to query the system and view results. The most prominent performance measures are based on citations received. Thus, the data base must contain of citation entries for individual papers, each of which contains identifying fields (e.g., author, title, date) and references (citations) to other papers. It can also contain in addition such information as the full text of articles, annotations to the articles, biographical information for each researcher, annotation for researchers (possibly provided by selected end users). The program that is provided is capable of rating articles by similarity based on characteristics such as the kinds of papers that are being cited, the journals in which the paper was published, and the author(s) who published the paper. Some particular implementations are described in more detail below. The provision of a performance measurement engine is also preferred wherein the engine is capable of measuring performance such as ranking articles by importance based on the citations that they have received from other articles. The distinction between the performance ranking and the similarity rating engines will be explained below. The aggregation system serves to categorize and group articles into aggregations (e.g., authors, institutions, or journals) for the most important use of this invention, which is the comparison of the performance of researchers (a particular aggregation) among their most similar peers. Finally, the user inquiry system (e.g., a web interface) allows users to request similarity ratings for particular researchers and/or show performance order rankings within the set of similar researchers.

Turning now to the individual components in more detail, the provision of a database containing the desired reference information is a mandatory aspect of the present invention. The database is configured to contain a variety of published information that is structured using various binding attributes, such as author names, article titles, publication information, biographical author information, affiliations, etc. Some of this information, such as author and title information is indeed mandatory. Someone skilled in the art can note that there are many possible data base constructions that can serve as an input.

The data base can be created either via hand-entry by operators, or via OCR and automated processing of the resulting text (in two sequential stages: first, identification of article meta data (e.g., title, author, citations); second parsing of individual meta data elements to code the citation itself into its own components, e.g., journal, volume, pages), or via combinations thereof. For example, a system can rely on a database of academic articles, researchers, and journals. The most important and essential data of the database is the information about articles' meta-data (such as author, title, journal, year, pages, other papers cited), and optionally such information as the abstract, the full text, and annotations (possibly by end users communicating with the system over the web). Within the structure of the database it may be necessary to adjust the formatting of the contents thereof to enable the system to judge the usefulness of entries. It may also be necessary to augment certain meta-information, such as cited author from the source documents, because author citation may be abbreviated (e.g., “I Welch” rather than “Ivo Welch”; the latter is more useful in distinguishing the entry from those written by Igor Welch). Methods that are useful for acting on the information within the database to affect the desired format changes are well known in the art so the details of their operation do not need to be discussed at length in the context of this application. The most common method would be to follow the link to the original article to expand shortened references, and the consultation of a data base of employment history of researchers.

Finally, optionally, such a system will typically or can have authentication mechanisms in order to distinguish between ordinary users and administrators. Ordinary users will be blocked from some operations (them primarily being limited to information queries, modifications of their own biographical information, and possibly feedback), while administrative users have access to mechanisms for changes to all records, rollback mechanisms to undo changes, the ability to add new fields, possibly the ability to add more information of different kinds by end-users, interfaces to social networking sites, etc.

To make the system more useful, the linked database may be fine tuned by including additional biographical information on researchers. For example, the author section of the database may contain a list of institutions that a researcher is known to have been affiliated with, or the years in which degrees or titles were obtained. Such a database (generated, hand-collected, or obtained through querying the researchers themselves [as, e.g., in RePeC or perhaps through a social networking site attached to the system]) can help identify researchers that have changed their names, e.g., through marriage. Such a database can also help disambiguate multiple researchers that share the same name. For example, one James Smith may have been at UCLA in 1974, a second James Smith at Ohio State in 1974. To identify which articles should be attributed to the first James Smith, the system can look up the affiliation in the original article. If an article was published around 1974 with James Smith from UCLA, it can be attributed to the first James Smith. Even without direct biographical resume information, it is often possible to make intelligent guesses about which James Smith is the author by looking at typical citing patterns, typical coauthors, and text-analysis (such as similar words or topics). Such analysis will also help to trace the same author through employment changes. An equally important application of such biographical information will be to narrow down the set of peer researchers to those with a particular characteristic or history, such as time of first publication, year of phd, or other cohort information.

As is the case in many other databases, one view of the database will be as a matrix of citations, in which the citing article may be the row and the cited articles may be the column. Each column slice then reveals by what articles each article is cited by.

Another essential part of the system is a similarity engine. There are a number of methods that can uncover similarity measures across papers or researchers. For example, publications can be deemed to be similar if they are linked (that is, if one paper cites the other, and more so if both papers cite one another), if they are citing the same kinds of papers, if they are cited by the same kinds of paper, if they contain similar text (e.g., similar sets of unusual phrases), if they have similar words in title or abstract, if they are published in the same journal or by the same researcher or by any combination of the previous or other metrics. Each similarity measure can be normalized in a variety of ways (e.g., dividing by the sum to add up to a normalized 100%). It is of note that the aggregation data could be used to feed back into the rankings of the articles themselves using a second aggregation pass (which in turn may feed back into the rankings of aggregated data). For example, if researcher A's and B's aggregated article ratings are very similar, than each of many articles belonging to A and B may be rated as a little more similar than they were rated before.

In the context of the present invention, while the fundamentals of performance measurement and ranking systems are well known, the ranking system in the present invention may be implemented in a variety of ways and it is possible that the weightings of articles may depend not only on the eigenvector. The current system does not use the most prominent performance measure in bibliometric data bases, the ISI impact factor. Instead, the following methods have been used:
Equal-weighted cites: It makes sense to normalize the citation matrix so that each article has the same number of votes. (In the ISI impact factor, this is not the case. Articles with more citations effectively vote more often.)
Journal-weighted cites: Alternatively, it makes sense to normalize the matrix so that articles in better journals (itself obtained by some ranking algorithm on the aggregation “journal”) receive more votes.
Age-normalized cites: It makes sense to normalize the matrix for citations per year. In this case, papers that have been longer in circulation are penalized.
Coauthor-normalized cites: For author rankings, it makes sense to penalize articles with more coauthors.
Star-outlier measure: Authors may be rated by the number of “star” articles that have at least a given number of normalized citations.
Research-determined cites: A weighting system that itself is derived from a statistical model that seeks to determine what weights best explain the location of researchers in higher vs. lower-ranked universities. This is a novel method of weighting and thus needs to be explained. A statistical regression (or similar procedure may be run) in which:

rank-of-researcher-institution=a+b*characteristics1+c* characteristics2+

where each observation is one researcher, where characteristic1 may be, e.g., the number of star papers a researcher has, how old the researchers' papers are, how old the researchers' high-impact papers are, what the average journal publication rank is, etc. It could also contain novel measures, such as the average technical sophistication of the researcher, whether papers are mathematical or even gender and other characteristics of researchers. a, b, c, etc. are estimated by the statistical procedure. Factors that are found to explain how well researchers are placed are then used in the ranking of researchers or journals.
Non-citation Based Performance Measures (e.g., Publication Record): Performance rankings can but need not be citation-based. They can be based on other criteria, such as the number of publications, the average journal-quality of publications, or a publication-quality weighted number of publications.
A combination of the preceding can also be used.

An important part of this invention is the inclusion of an aggregation engine to gather single data entries (articles and results on articles) into bigger categories (such as researchers and results for researchers). In this manner the present invention employs a similarity rating engine in the context of aggregations, and specifically in the context of the category of a “researcher.” There are two methods to do so. Each researcher's articles may all be aggregated into one record, and the similarity algorithm may be run thereon. Optionally, articles may be ranked by similarity first, and then the similarities are aggregated over each researcher.

Using the end user interface, a user of the system would use an interface over the World Wide Web to query for particular keywords, articles, researchers, institutions or journals. When the query is found to yield a unique result, the most similar peers are returned, either together with the ranking of peers or rankings among peers, or with easy accessibility within the system to such peer rankings. Because the database does not change very often, most of the information can be computed and stored even before the end user query. Fields can be sorted. For example, an overnight batch program can compute similarity metrics for each researcher, and then attach to each researcher a link to the 30 most similar researchers. When the end user queries, e.g., “Ivo Welch,” the server looks up “Ivo Welch” and thus already knows how the peer researchers to include in the same table. It is also possible that instead of a query-and-search engine, the interface could be a set of pre-prepared tables (of similar researchers), which then leave it to the end user to find the researcher in question and then look up the performance metrics of similar researchers just next to the particular researcher in question.

The important aspect of the output is that the user has convenient access to two-dimensional information, the set of performance measures (the first [impact] dimension) within a set of similar ratings (the second [peer] dimension). This can be done sequentially: a first web page may present the set of similar researchers, from which the user can select the researchers to be included and ranking information is determined in a second step; or it can all be presented on the same page in a two- or more-dimensional table. The peer similarity rating is what determines the set of researchers for which information will be provided.

An observer skilled in the art will recognize that there are many mechanisms to display the set of peers. For example, one equivalent output system would print all researchers (not just peers), and then allow the end-user to sort researchers by the characteristic of “similarity,” so that the end-result is a by-similarity peer rating ordered list, from which the end user can choose the researchers in close proximity that are to be compared. Similarly, the display can be graphical to show in one or more dimensions where similar researchers are located relative to one another. The display of similar researchers together with or in close proximity to an engine that can show comparative performance measures and rankings is this task that is not easily accomplished today.

In contrast to the prior art, the present invention provides improvements via the use of common aggregation. In existing web-search engines, performance measurement, order ranking and similarity results are usually “atomistic,” i.e., article (individual web page) based, and often functionally separate from performance rankings. Existing search engines either provide importance rankings or similarity ratings or a combination of both, but the point of the invention here is to provide rank information within a set of similar peer results (pages, articles, researchers), and de-emphasis of non-peer results (web pages, articles, researchers). Most importantly, the present invention primarily applies to aggregations of atomistic publications into broader categories (such as researcher) that the results must have in common, and not as much to the individual atoms (articles) themselves. Further the present system exhibits preference towards similarity in contrast to existing web-search engines where similarity ratings are most useful to avoid displaying similar pages. For example, a user searching for “international patent” would probably not want to see 50 results that are for “international patent” documents from similar forms from the U.S. PTO. Instead, a good web-search engine would more likely use the similarity rating to display some U.S. PTO pages, some British PTO pages, some attorney pages, etc. My invention uses similarity information in the opposite way. It seeks to present performance measures only among similar researchers (peers), and to suppress the display of performance metrics of dissimilar researchers.

Finally, the present invention provided for automated similarity ratings. In my invention, the user does not need to specify ex-ante the research area upon which the similarity is to be based. Instead, the system can choose peers automatically, possibly refined with further user specification. Existing bibliographic systems offer similarity ratings of individual papers, but none offers computer-generated similarity ratings for aggregated categories, such as researchers, much less in a display of results of individual researchers relative to a peer group. (The fact that after 20 years no such system has been offered attests to its non-obviousness.)

An example best illustrates the system. (The specific values are not correct.)

### Sample End User Interaction:

Query Interface for User Input (Search Page on the WWW):
This embodiment of this system allows the end-user to select how wide the set of comparable peers should be. In the sample search page above, this is accomplished by giving a number of peers desired and/or the width of researcher cohort, but other mechanisms should be encompassed by this invention, too. Similarly, there are many other variations that would allow the end user to identify a unique researcher, e.g., a pull-down list, a by-university list, a graph that plots researchers as points in space and thereby allows end users to identify researchers that appear similar, etc. A reader skilled in the art should recognize the variety of different search mechanisms and output choices that are part of this invention.

### A Minimal Stage 1 Output Page to User Query

Similar Researchers to Ivo Welch: Raghuram Rajan, Milton Harris, Jay Ritter, and John Parsons.

The system claims novelty if a goal of the system is to identify these similar researchers so that their performance can then be easily measured one-by-one (to make a good comparison), or relative to one another. Here, this can be accomplished through another web page (of the same system) into which the user would type the names of the researchers sequentially.

A More Elaborate Stage 1 Output Page to User Query
In this embodiment, the user can sort the display by field. The set of similar researchers is presented together with other information. A second feature is that the user can select specific researchers for a detailed comparison. A possible result thereof is presented below.

### A Graphical Stage 1 Output Page to User Query

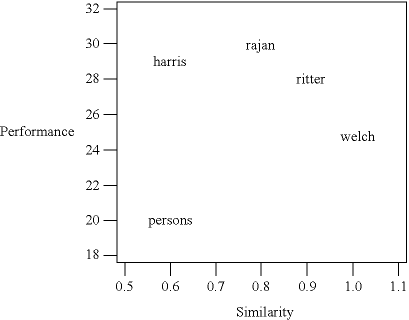 [0063] In this embodiment, the user could be permitted to select researchers by clicking on one or more researchers noted in the graph, which on its x axis displays the similarity.

### An Optional Second-Stage Detailed Tabular Display Page

Results for Selected Researchers: “Ivo Welch”, “Raghuram Rajan”
Biographical Information

| | | |
|---|---|---|
| Researcher | Raahuram | Ivo Welch |
| | Rajan | |
| Ph.D. | MIT, 1990 | Chicago, 1991 |
| Prior Appointments | Chicago, | UCLA, Yale, |
| | World | Brown |
| | Bank | |
| Web Page | Link | Link |
| C.V. | Link | Link |
| Other Biographical | . . . | . . . |
| Fields | | |

Similarity

| | | | |
|---|---|---|---|
| Similarity | Raghuram | 100% | 80% |
| (Citation | Rajan | | |
| Based) | Ivo Welch | 80% | 100% |
| Similarity | Raghuram | 100% | 70% |
| (Topic | Rajan | | |
| Based) | Ivo Welch | 70% | 100% |
| Similarity | Raghuram | 100% | 75% |
| (Journal | Rajan | | |
| Based) | Ivo Welch | 75% | 100% |
| Other | | | |
| Similarity | | | |
| measures | | | |
| . . . | . . . | | |

Rankings
Plain Citation Based

| | | |
|---|---|---|
| Number of Citations | 1,200 | 1,024 |
| Unit-Normalized | 850 | 750 |
| Citations | | |
| Importance- | 350 | 250 |
| Normalized Citations | | |
| Journal-Normalized | 275 | 300 |
| Citations | | |
| Coauthor- | 850 | 750 |
| Normalized Citations | | |
| Highest Cited Paper | 300 | 450 |
| Other Statistical | . . . | . . . |
| Fields | | |

Excluding Self-Citations

| | | |
|---|---|---|
| Number of Citations | 1,150 | 800 |
| Unit-Normalized | 822 | 710 |
| Citations | | |
| Importance- | 310 | 220 |
| Normalized Citations | | |
| Journal-Normalized | 205 | 230 |
| Citations | | |
| Coauthor- | 834 | 343 |
| Normalized Citations | | |
| Highest Cited Paper | 298 | 440 |
| Other Statistical | . . . | . . . |
| Fields | | |

Not Citation Based

| | | |
|---|---|---|
| Number of | 25 | 26 |
| Publications | | |
| Journal-Quality | 65 | 45 |
| Weighted Number of | | |
| Publications | | |
| Average Journal- | 65 | 45 |
| Quality | | |
| Appearance on | 15 | 5 |
| Reading Lists | | |
| Other Statistical | . . . | . . . |
| Fields | | |

Other

| | | |
|---|---|---|
| Unusual Patterns | None | Low |
| | | Coauthor + Journal |
| | | Normalized |

Click fields for explanations.

In this example, the end user has selected only two researchers, e.g., through the previous main system stage 1 output pages, and is receiving a comparative (tabular) description of various measures of these two researchers.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. An automated system for searching for publications and aggregations of said publications contained within an academic citation database comprising:
an accessible database containing a plurality of publications, said publications including academic papers, their citations and identifying information associated with each of said academic papers, said identifying information including at least the researcher name, the researcher affiliation, and the journal and year of publication; and
a computer based user interface connected to said accessible database via an electronic network, said interface configured to allow an end user to query said database,
wherein said system can aggregate said individual publications within said database using said identifying information,
wherein said system can compute a similarity rating between said individual publications or said aggregated publications or both,
wherein said system can compute a performance measurement rating for individual publications or for said aggregated publications or both,
said interface allowing said end user to query said database to identify discreet publications and specific individual aggregations containing publications that include high similarity ratings to said discrete publications or aggregated publications and to further identify aggregations of publications having identifying information that is similar to the identifying information for the discrete publication or aggregation of interest to the end user.

2. The automated system of claim 1, wherein the database can determine performance measures of the aggregations.

3. The automated system of claim 2, wherein the user interface web page presents a user with a set of peers that are drawn from the set of aggregations and which were determined to be most similar.

4. The system of claim 3, wherein the web page further displays said performance measures for the aggregated publications in reasonably close proximity.

5. The automated system of claim 1, wherein the user interface is a web page that allows a user to query the publications within the database for at least one aggregation.

6. The automated system of claim 5, wherein the user interface web page presents a user with a set of peers that correspond to equivalent aggregations and were determined to be most similar.

7. The system of claim 6, wherein the web page further displays said performance measures for aggregations.

8. The automated system of claim 1, wherein user interface is a web page that allows a user to query the publications within said database for at least two aggregations.

9. The automated system of claim 8, wherein the web page further displays said performance measures for other aggregations.

10. The system of claim 11, wherein the display includes a comparison between the performance measures for the at least two queried aggregations.

11. The system of claim 1, wherein the performance measure itself is based on a statistical analysis of said publications based on their publication in top-rated journals or their being written by researchers employed by top-rated universities.

12. The system of claim 1, wherein the interface contains both similarity rating and performance measure for single publications in a two-dimensional format on the same page, specifically the set of similar publications with associated performance rankings.
